(19) United States
(12) Patent Application Publication
(10) Pub. No.: US 2012/0125706 A1
(43) Pub. Date: May 24, 2012

(54) WIG CRAFT HAVING HYBRID PROPULSION MEANS

(75) Inventors: Han Jin Lee, Daejeon (KR); Chang Gu Kang, Daejeon (KR)

(73) Assignee: WINGSHIP TECHNOLOGY CORP., Daejeon (KR)

(21) Appl. No.: 13/321,134

(22) PCT Filed: Oct. 18, 2010
(86) PCT No.: PCT/KR2010/007138

§ 371 Date: Feb. 6, 2012

(30) Foreign Application Priority Data
Mar. 30, 2010 (KR) 10-2010-0028298

(51) Int. Cl. B60V 1/14; B63H 7/02

(52) U.S. Cl. 180/117

(57) ABSTRACT

A wing-in-ground (WIG) craft having a streamlined WIG craft body, a main wing mounted on opposite sides of the WIG craft body, a pylon mounted on the WIG craft body or the main wing, and a combined thruster having a primary thruster unit mounted on the pylon, and an auxiliary thruster unit serving as a booster used when the WIG craft takes off from a water surface.

### CROSS-REFERENCE TO RELATED APPLICATIONS

This application is the U.S. national phase of the International Patent Application No. PCT/KR2010/007138 filed Oct. 18, 2010, which claims the benefit of Korean Patent Application No. 10-2010-0028298 filed Mar. 30, 2010, the entire content of which is incorporated herein by reference.

### BACKGROUND

1. Field of the Invention

The invention relates, in general, to a wing-in-ground (WIG) craft and, more particularly, to a WIG craft with a combined thruster that includes a primary thruster unit and an auxiliary thruster unit.

2. Description of the Related Art

Generally, a WIG craft is one that uses the ground effect, which refers to the increased lift and decreased drag that a wing generates when a craft is flown close to the surface. The ground effect is a phenomenon that is generated only when speed has increased beyond a certain point. The WIG craft however has the problem that, for the same speed, it requires greater thrust when used on water than on land because of the increased resistance of the water that is generated when the WIG craft goes from standby to takeoff.

Accordingly, a WIG craft that was developed and made in Russia was configured with a separate thruster mounted on a head part to support the thrust and overcome the resistance of the water, and fast air flow is induced below the wing at low speeds so the WIG craft can take off quickly from the surface of the water. However, the output efficiency at low speed of the gas turbine thruster that is used as the additional thruster is low, causing the problem of excessive fuel weight being added relative to its output.

In Europe, studies have been conducted into a hover wing using a hydrofoil or a floating skirt provided, e.g. in an air-cushion machine, in order to solve this problem of how to lift the WIG craft quickly at the initially low speed, so as to reduce the resistance of the water. However, even in this case, unsolved problems still remain, such as the difference between engine outputs that are required when the WIG craft takes off and cruises become greater.

That is, the existing WIG craft used a turbo prop thruster in order to secure output efficiency at a relatively lower speed compared to aircraft. However, as most medium or large-sized aircraft recently use a turbo fan or turbo jet thruster, it becomes difficult to acquire a turbo prop thruster with the desired output.

Particularly in a propeller type thruster, as the output and thrust of an engine increase, the size of a propeller should also increase. However, a problem arises in that the material, revolution speed, and the like of a propeller limit its size. Thus, in order to fabricate a large-sized WIG craft, there is a need to provide the WIG craft with the thrust that it requires upon takeoff while dividing it with a plurality of thrusters. If the thruster uses the turbo prop thrusters, this can cause problems such as a shortage of space in which to mount the propeller.

Contrary to this, since the turbo fan or turbo jet thruster is an apparatus that is devised to secure the maximum efficiency at high speed operation as happens in aircraft, the WIG craft that is operated at mid-to-low speeds has the problem of reduced output efficiency.

### SUMMARY

Accordingly, the invention has been made keeping in mind the above problems occurring in the related art, and an embodiment of the invention provides a WIG craft with a combined thruster comprising a turbo prop thruster, a primary thruster of the WIG craft, and a turbo fan or turbo jet thruster, an auxiliary thruster serving as a booster used when the WIG craft takes off from a water surface.

An embodiment of the invention provides a WIG craft including: a streamlined WIG craft body, a main wing mounted on opposite sides of the WIG craft body; a pylon mounted on the WIG craft body or the main wing; and a combined thruster including a primary thruster unit mounted on the pylon, and an auxiliary thruster unit and serving as a booster for when the WIG craft takes off from a water surface.

In the WIG craft, the primary thruster unit may be a turbo prop thruster, and the auxiliary thruster unit may be a turbo fan or turbo jet thruster.

In the WIG craft, the configuration of the turbo fan or turbo jet thruster may be such that an intake is located behind a propeller of the turbo prop thruster so as to receive the slipstream of the propeller, thereby improving thrust efficiency.

The WIG craft may be provided with the turbo fan or turbo jet thruster as an auxiliary thruster unit in addition to the turbo prop thruster as a primary thruster unit, providing the effect of efficiently utilizing thrust upon the WIG craft taking off from a water surface.

Further, the intake of the turbo fan or turbo jet thruster may be positioned behind the propeller of the turbo prop thruster so as to receive the slipstream of the propeller, thereby providing the effect of improving the thrust efficiency.

The auxiliary thruster may be mounted on the primary thruster.

### BRIEF DESCRIPTION OF THE DRAWINGS

The above and other embodiments, features and advantages of the invention will be more clearly understood from the following detailed description when taken in conjunction with the accompanying drawings, in which:

FIG. 1 is a side view showing a WIG craft having a combined thruster according to an embodiment of the invention; and

FIG. 2 is a plan view of the WIG craft having the combined thruster.

### DETAILED DESCRIPTION OF THE INVENTION

Reference will be made in greater detail to a preferred embodiment of the invention, an example of which is illustrated in the accompanying drawings. Wherever possible, the same reference numerals will be used throughout the drawings and the description to refer to the same or like parts.

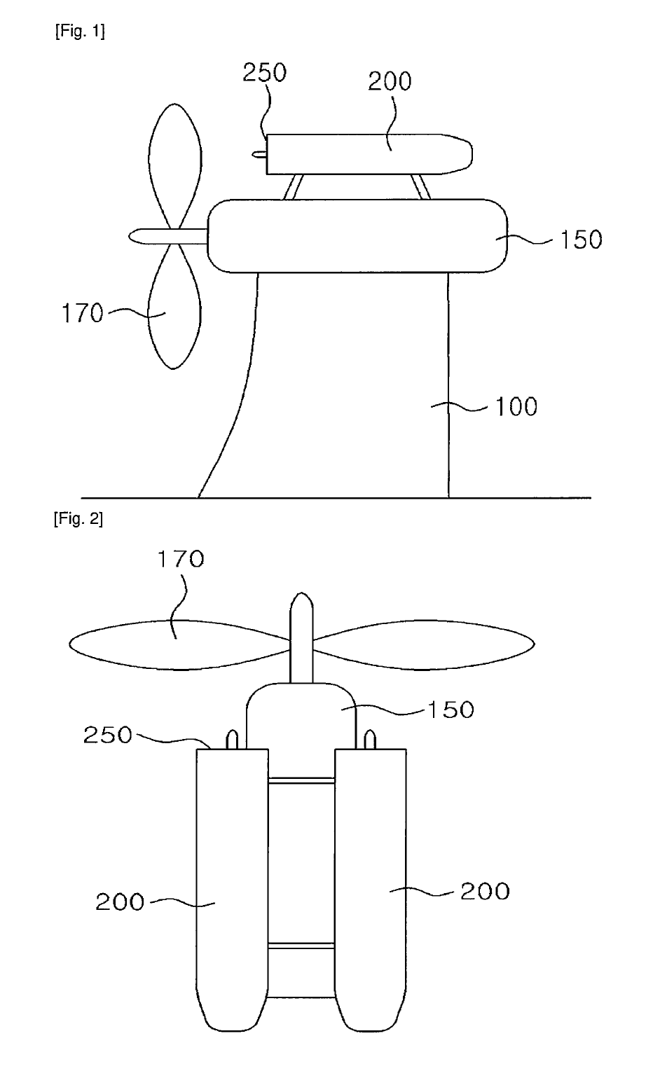

FIG. 1 is a side view showing a WIG craft having a combined thruster according to an embodiment of the invention, and FIG. 2 is a plan view of the WIG craft having the combined thruster.

Referring to FIGS. 1 and 2, the WIG craft comprises a longitudinally streamlined WIG craft body (not shown), a main wing (not shown) mounted on opposite sides of the WIG craft body, a pylon 100 mounted on the WIG craft body or the main wing, and a combined thruster including a primary thruster unit 150 mounted on the pylon 100 and an auxiliary thruster unit 200 serving as a booster used when the WIG craft takes off from a water surface.

The primary thruster unit 150 serves to provide thrust when the WIG craft takes off and cruises. It is preferred that the primary thruster unit 150 be a turbo prop thruster, which is a type of gas turbine thruster that has high performance at low speed, so that it can provide the maximum efficiency within the range of velocity of 150˜250 km/h that belongs to the general sailing velocity of WIG crafts.

It is preferred that the auxiliary thruster unit 200 be located on the primary thruster unit 150 and be a turbo fan or turbo jet thruster.

The turbo fan thruster basically has the same construction as the turbo jet thruster except that incoming air is separately exhausted through a gas generator and a low pressure fan. That is, air introduced through the fan is compressed to high pressure and exhausted to the outside through a nozzle, whereas air introduced into the gas generator is discharged through an exhaust nozzle by the same process as in the turbo jet thruster.

The turbo fan thruster is economical because it has higher thrust at intermediate or low speed and improved fuel consumption than the turbo jet thruster. Further, since an air stream from the fan nozzle surrounds the high speed exhausted gas that is discharged from the exhaust nozzle so as to considerably reduce noise, the turbo fan thruster is currently widely used in most military aircraft, passenger airplanes and the like.

Thus, the turbo fan or turbo jet thruster is used as the auxiliary thruster unit 200 to provide the additional thrust required upon takeoff of the WIG craft from the surface of the water. The turbo fan or turbo jet thruster may preferably be provided with one or two units of turbo fans or turbo jet thrusters.

The turbo prop thruster and the turbo fan or turbo jet thruster serve to provide thrust, dividing total thrust required upon the takeoff of the WIG craft from the surface of the water, the turbo prop thruster may use a small area propeller 170.

In the meantime, the turbo fan or turbo jet thruster is arranged such that an intake 250 thereof is located behind the propeller 170 of the turbo prop thruster. Thus, when the WIG craft takes off, the slipstream of the propeller 170 is introduced through the intake 250, thereby improving the thrust efficiency.

In addition, although the auxiliary thruster unit 200 may be used when the WIG craft takes off from the surface, or when the turbo prop thruster as a primary thruster unit is out of order, it need not be used when the WIG craft is in normal sailing mode.

Further, the invention provides the advantage of the WIG craft not needing additional space and structure because the auxiliary thruster unit 200 may be mounted on the primary thruster unit 150.

Although a preferred embodiment of the invention has been described for illustrative purposes, those skilled in the art will appreciate that various modifications, additions and substitutions are possible, without departing from the scope and spirit of the invention as disclosed in the accompanying claims.

1. A wing-in-ground (WIG) craft comprising:
a streamlined WIG craft body;
a main wing mounted on opposite sides of the WIG craft body;
a pylon mounted on the WIG craft body or the main wing; and
a combined thruster including a primary thruster unit mounted on the pylon, and an auxiliary thruster unit serving as a booster used when the WIG craft takes off from a water surface.

2. The WIG craft according to claim 1, wherein the primary thruster unit is a turbo prop thruster, and the auxiliary thruster unit is a turbo fan or a turbo jet thruster.

3. The WIG craft according to claim 2, wherein the turbo fan or turbo jet thruster is arranged such that an intake thereof is located behind a propeller of the turbo prop thruster so as to receive the slipstream of the propeller, thereby improving thrust efficiency.

4. The WIG craft according to claim 1, wherein the auxiliary thruster unit is mounted on the primary thruster unit.
